(19) United States
(12) Patent Application Publication
(10) Pub. No.: US 2006/0178240 A1
(43) Pub. Date: Aug. 10, 2006

(54) Power transmission drive

(75) Inventor: Tino Hansel, Emskirchen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA- Schaeffler KG, Herzogenaurach (DE)

(21) Appl. No.: 10/565,088

(22) PCT Filed: Jul. 21, 2004
(86) PCT No.: PCT/EP04/08138

§ 371 Date: Jan. 18, 2006

(30) Foreign Application Priority Data
Aug. 13, 2003 (DE) 10337222.9

(51) Int. Cl. F16H 7/12; F16H 7/14; F16H 7/08

(52) U.S. Cl. 474/135; 474/87; 474/101; 474/133; 474/117

(57) ABSTRACT

A power transmission drive (1) is provided, in which sensors (11a, 11b) detect an oscillating angle deviation between a driven member (3) and a drive member (4b), and signal the deviation to a controller (14). If a limit value is exceeded, the controller (14) initiates an emergency operation of the internal combustion engine.

### FIELD OF THE INVENTION

The invention relates to a device, with which an oscillating angle deviation or a rotating angle deviation between a driven member and a drive member or its secondary effect on the drive shaft can be detected in a power transmission drive designed as a synchronous drive. Here, the driven member or the drive member of the power transmission drive interacts, for example, with an electronic controller of the internal combustion engine.

### BACKGROUND OF THE INVENTION

Power transmission drives, which are driven, for example, by a belt pulley connected to the crankshaft of the internal combustion engine, are exposed to function-specific rotational irregularity caused by the combustion process of the internal combustion engine. The rotational irregularity of the internal combustion engine feeds changing rotational moments into the power transmission drive, which are transferred directly to the units connected to the power transmission drive. In this way, power transmission oscillations are produced in connection with a disadvantageous noise source and increased wear. For power transmission drives, which are provided for driving units with large rotational masses, for example, generators, air-conditioning compressors, or pumps, this effect is amplified and leads, in particular, to a short service life of the power transmission means. In power transmission drives, which are designed for driving the camshafts of an internal combustion engine and which are designated as control drives, the changing moments of the valve drive, i.e., the activation of the gas-exchange valves, also acts on the power transmission means.

From DE 101 55 199 A1, a class-defining state of the art is known. This device, which is designed as a wear indicator for a power transmission drive, triggers a signal as soon as a rotating angle difference between two rotating shafts exceeds a limit value. The device limits itself to detecting a disruption in the function and forwarding this as a signal.

### SUMMARY OF THE INVENTION

Starting from the known state of the art, the present invention is based on the objective of monitoring the function of a power transmission drive in the operating state of the internal combustion engine, wherein a disruption does not immediately lead to shutdown of the internal combustion engine.

According to the invention, this objective is met by the features of claim 1.

To meet the mentioned objective, according to the invention there is at least one sensor, a transducer, which detects an oscillating angle deviation, a rotating angle deviation, an irregularity in the rpm, or a correcting movement between the driven member and at least one drive member of the power transmission drive. For this purpose, a sensor or a transducer, which, in the operating state of the internal combustion engine, feeds measurement values as actual values to an electronic controller, which includes an evaluation unit or a measurement value detector, is allocated to a rotating component of the power transmission drive according to the invention. Preferably, a sensor is allocated to the driven member and to the drive member. Thus, for example, an oscillating angle deviation or a rotating angle deviation of the camshaft can be detected. The sensor transmits the detected actual values as a signal to the electronic controller of the internal combustion engine. The control system or the controller calculates a correcting value through comparison between actual values and desired values, as soon as a defined limit value is exceeded. The control is realized in that a control value is formed from an oscillating angle deviation or a deviation of the irregularity in the rpm with reference to a desired value. The controller can then initiate an emergency program, with which the internal combustion engine can continue to operate, for example, in partial-load operation in connection with a limit in rpm. For this purpose, preferably a control element, an actuator, or a correcting element, with which the correcting value of the controller can be converted into an operation, is allocated to the correcting element; i.e., in the controller of the internal combustion engine, a comparison is performed with desired values and the result is subsequently transmitted to a correcting element.

Advantageously, the desired values are defined in the electronic control module so that the device according to the invention detects and indicates the failure of a component of the power transmission drive when the failure has already begun to show. Thus, a defect can be recognized at an early stage and an emergency operation can be initiated, which prevents resulting damages, shutdown, and complete failure of the internal combustion engine. The device according to the invention enables a vehicle with an internal combustion engine that has experienced a functional disruption to one member or one take-off unit of the power transmission drive to reach the repair shop without outside help.

Further advantageous configurations are the subject matter of the dependent claims 2 to 16.

In a preferred configuration of the invention, a free engine clutch is allocated to a driven member or a drive member of the power transmission drive designed as a synchronous drive, wherein the device according to the invention monitors the function of the free engine clutch when the internal combustion engine is operating. The functional principle of the free engine clutch guarantees that the power transmission means is decoupled only for an accelerated angular velocity and, on the other hand, for a delay, triggers a delay in the drive units, which is smaller than that of the power transmission drive, whose power transmission means is connected to the internal combustion engine via the driven member. Thus, especially for units with a large rotational mass, a disadvantageous oscillating movement caused by the rotational irregularity of the internal combustion engine, which has, in particular, a disadvantageous effect on the service life of the power transmission means, is prevented.

Here, the basis or foundation of the function test is the reaction of the free engine clutch to its drive shaft. A blocked free engine clutch causes a large irregularity in the rpm initiated in the power transmission drive. Thus, the oscillating angle deviation increases, associated with a greater load on the tensioning device of the power transmission drive. The oscillating angle or the rotating angle is determined by a transducer, which detects an angular position, i.e., angle deviation and/or an rpm deviation of the relevant driven member or drive member and feeds this as a measurement value to the controller of the internal combustion engine. Advantageously, with the help of sensors, which are allocated to the free engine clutch, a relative movement between an inner ring and an outer ring of the free engine clutch is detected and transmitted as a signal to the electronic controller. When predetermined limit values are exceeded, an emergency program can be initiated, in which the internal combustion engine can be operated, at least for a limited time, despite a defective or failed free engine clutch.

In the device according to the invention, when an actual value, which points to a defective free engine clutch and which is defined as a limit value, is exceeded, the controller automatically transfers to an emergency program. This measure enables the operation of the internal combustion engine at a lower power level and permits use of the vehicle despite a defective free engine clutch.

The power transmission means of the power transmission drive according to the invention is connected to a running wheel, especially a belt pulley, of another power transmission drive designed as a control drive for the internal combustion engine. According to the invention, another power transmission drive is connected on the output side of the control drive designed for driving the camshaft of the internal combustion engine. The device according to the invention can be transferred to a coupled drive, for which a power transmission means of the subsequent power transmission drive is connected to a running wheel of the power transmission drive designed as a control drive for the internal combustion engine. Such an output-connected power transmission drive connects, for example, to the camshaft drive wheel of the control drive and is used, for example, for internal combustion engines, in which the cylinders are arranged in the shape of a V, for driving additional drive units arranged between the cylinders of the internal combustion engine.

Advantageously, the internal combustion engine is provided with rpm sensors, which are preferably allocated to the crankshaft and the camshaft. These sensors, in connection with an electronic controller or a regulating device, the engine management, enable the monitoring and controlling of, for example, the firing time, the injection start, and/or camshaft adjustment for the internal combustion engine. In this way, the controller detects irregularities in the oscillating angle deviation, the rotating angle deviation, or the rpm outside of a predetermined tolerance.

Deviations from default values trigger functional disruptions of units of the synchronous drive, such as, for example, a defect of the tensioning device, the slide rail, the deflection roller, the water pump, the valve drive, or the camshaft adjuster.

The controller according to the invention is designed advantageously so that when tolerances of static and/or dynamic rotating angles or oscillating angles are exceeded, an emergency program is initiated. Here, the internal combustion engine is operated, for example, with a partial load and/or at a reduced rpm. In addition, the controller can initiate a shutdown of the internal combustion engine, for example, for a major defect of a component.

Another configuration of the invention relates to a power transmission drive, which includes the power transmission means for a fuel pump. For example, the previously described coupled drive is suitable for driving a fuel injection pump for Otto engines or a high-pressure pump for common rail diesel engines, wherein advantageously the running wheel or belt wheel of the fuel pump includes a free engine clutch. Alternatively, the invention includes the free engine clutch on the driven side, i.e., integrated into the camshaft in the running wheel or belt wheel of the driven side. For an impermissible oscillating angle deviation, rpm irregularity, and/or rotating angle deviation between the driven member and the fuel pump, according to the invention the emergency program is initiated, with which, for example, the internal combustion engine can continue to operate in partial load operation for a limited time. The emergency program prevents full-load operation and thus effectively prevents resulting damage of the belt wheel of the fuel injection pump due to a defective free engine clutch in the drive member.

With the help of corresponding software, the controller can initiate an emergency program, which provides a fuel regulating variant, in which the pressure regulating valve is pressurized and thus the triggered changing rotational moments are significantly reduced. This measure is advantageous especially for high-pressure pumps, which are used for common rail diesel combustion engines.

Advantageously, the free engine clutch is used in a running wheel or in a belt wheel between an inner ring locked in rotation with a pump shaft of the fuel injection pump and an outer ring surrounding the free engine clutch. For detecting relative movement between the inner ring or hub and an outer ring or housing, sensors, which transmit the relative movements as a signal to the electronic controller, are allocated to the free engine clutch.

As an alternative to achieving protected mounting of the free engine clutch, it has been proposed to arrange this within the pump housing, for example, between two journals of the high-pressure pump. For this purpose, a first journal engages in a pot-shaped receptacle of the second journal with play, wherein the free engine clutch is inserted into a self-adjusting ring gap between the journal and the receptacle.

The invention includes all constructions of free engine clutches, which are preferably allocated to the running wheels or belt wheels of the driven member or to the drive members. As a free engine clutch, preferably a clamping body free-wheel or a clamping roller free-wheel can be used. Alternatively, a sleeve free-wheel or a wrap-around band free-wheel are suitable.

Advantageously, the device according to the invention includes a sensor, which has a compact shape and performs an exact measurement. For this purpose, the sensor is used, for example, in the running wheel or belt pulley of the driven member or the drive member or is allocated to this member and detects, as the measurement value, the relative movement of the components of the free engine clutch moving relative to each other. Thus, the function of the free engine clutch can be monitored simultaneously. A large rpm difference in the components, between which the free engine clutch is used, can be an indication of slippage and matching rpm values can be an indication of blockage. As sensors, preferably a non-contact sensor or transducer, for example, a Hall sensor or an inductive rpm sensor, are suitable.

The device according to the invention further enables, for example, monitoring of the function of the water pump, the tensioning device, the slide rail, the camshaft adjuster, and the power transmission means, i.e., all members or components in connection with the power transmission drive.

In parallel to an emergency program initiated by the controller of the internal combustion engine due to a maximum oscillating angle deviation or rpm deviation being exceeded between the driven member and the drive member, according to the invention the controller triggers an acoustic or optical signal. This signal, for example, notifies the driver of the vehicle that a defect has occurred in the power transmission means of the fuel injection pump and therefore the internal combustion engine has shifted to emergency operation. The emergency operation, which prevents full-load operation of the internal combustion engine, enables the vehicle to reach the closest repair shop despite the damage sustained by the vehicle.

With the acoustic or optical signal triggered by the regulating device, the driver of the vehicle immediately receives notification of a functional disruption. For this purpose, it has been proposed to provide several different signals, which are each allocated to a unit, whereby the driver recognizes the defective unit, for example, with reference to the signal, and consequently can immediately adjust his driving or his destination accordingly.

Furthermore, in the device according to the invention, the controller is provided with a fault memory. This software measure enables the repair shop personnel to determine the functioning and the state of the free engine clutch with the help of a diagnostic machine for the repair work. The fault memory is advantageously designed so that it detects both the limit value-exceeding measurement values and also measurement values, which correspond to a tolerance array set for the limit value. Such measurement values point to an imminent failure of a member or a component of the power transmission drive, for example, a free engine clutch. Thus, a looming failure of the free engine clutch can be recognized and further damages or an unplanned visit to the repair shop can be avoided through timely replacement.

Preferably, the device according to the invention is designed so that the actual values and the desired values are compared in the electronic controller in a warm-running internal combustion engine. Preferably, the controller takes into account an initial elongation of the toothed belt, in which the controller starts the comparison between actual values and desired values after an operating period that can be preset after start-up or replacement of the toothed belt.

Furthermore, in the device according to the invention, a measurement value comparison between the driven member and the drive member for determining the rotating angle is performed continuously in the operating state of the internal combustion engine. This measure guarantees the triggering of an emergency program, even in the early stage of a looming failure, for example, of the free engine clutch, for preventing damage.

The device according to the invention is suitable for all power transmission means used today in internal combustion engines, such as, especially toothed belts, flat belts, or chains. The device according to the invention, which is designed for a power transmission drive designed as a synchronous drive, further comprises a tensioning device, which is supported by a positive fit in the region of a loose section on the power transmission means.

According to the invention, the device can also be combined with a power transmission drive without a separate tensioning device. For this purpose, preferably a drive member can pivot supported by a spring arrangement on the power transmission means. A suitable device is, for example, a pivoting high-pressure pump, which thus simultaneously assumes the function of the tensioning device.

In addition, the device according to the invention for power transmission drives of internal combustion engines can be provided with a starter generator, which drives a power transmission means or a belt and which takes over the function of a starter and a generator. Depending on the operating state, in the start mode of the power transmission means of the starter generator on the internal combustion engine and in the operating mode, the members or units of the internal combustion engine connected to the power transmission drive are driven.

### BRIEF DESCRIPTION OF THE DRAWINGS

A preferred embodiment of the invention is shown in the figures. Shown are:

FIG. 1 the schematic structure of a power transmission drive designed as a control drive for an internal combustion engine, to which is allocated another power transmission drive as a coupled drive;

FIG. 2 the output-connected power transmission drive according to FIG. 1 designed as a coupled drive;

FIG. 3 the view III-III according to FIG. 2, which represents a free engine clutch in the installed state in a sectional view;

FIG. 4 a diagram, in which a rotating angle deviation of a member is shown with and without a free engine clutch.

### DETAILED DESCRIPTION OF THE DRAWINGS

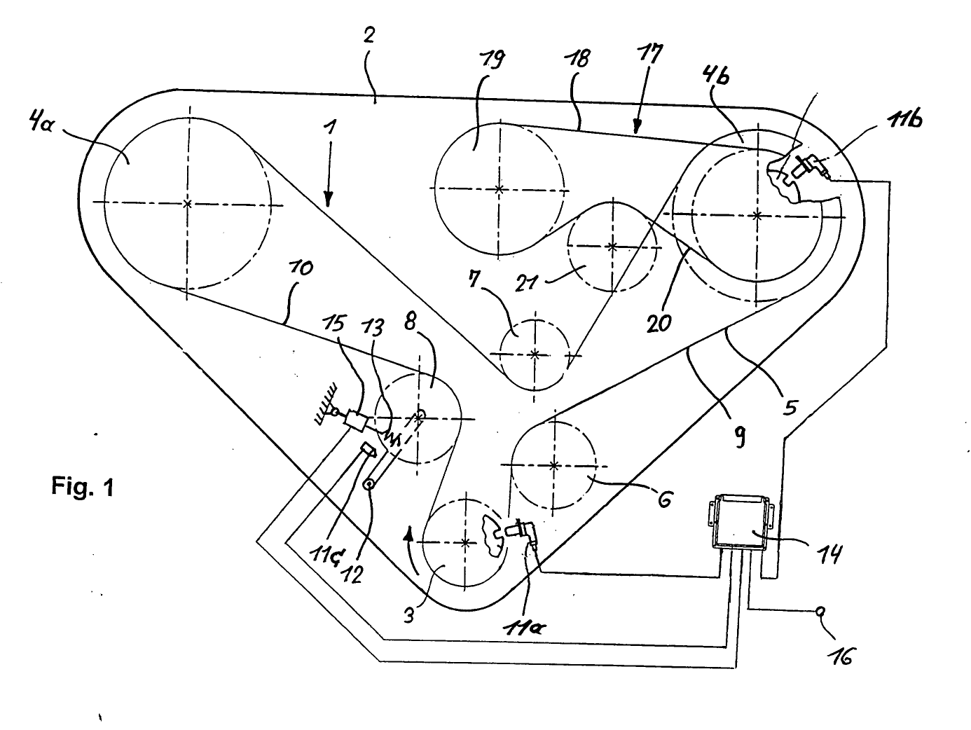

FIG. 1 illustrates the structure of a power transmission drive 1 designed as a synchronous drive for an internal combustion engine 2. The control drive 1 is used particularly for driving two drive members 4a, 4b arranged in the shape of a V relative to a driven member 3. The driven member 3 is formed by a belt pulley, which is connected to the drive members 4a, 4b via a power transmission means 5, especially a toothed belt, locked in rotation with a crankshaft of the internal combustion engine 2. These drive members represent belt pulleys, which are each connected to a camshaft for activating gas-exchange valves of the internal combustion engine 2. The power transmission drive 1 designed for driving the camshafts is designated as a control drive. For achieving a defined angle of belt wrap for the power transmission means 5, a first deflection roller 6 is allocated to the power transmission drive 1 between the driven member 3 and the drive member 4b.

A second deflection roller 7 or alternatively a water pump is supported against the power transmission means 5 between the drive members 4a and 4b, wherein for increasing the angle of belt wrap, the deflection roller 7 is arranged in the direction of the driven member 3 between the camshafts. Correspondingly, the deflection rollers 6, 7 are each allocated to a tensioned section 9 of the power transmission means 5. The power transmission drive 1 rotating in the direction of the arrow, i.e., in the clockwise direction, further comprises a tensioning device 8, which is supported with a positive engagement against the power transmission means 5 supported by a spring element 13 on an loose section 10 of the power transmission means 5, i.e., between the driven member 3 and the drive member 4a.

Sensors 11a, 11b, which transmit signals, for example, periodically to a controlling device, a controller 14, are allocated to the driven member 3 and the drive member 4b of the power transmission drive 1. A comparison with preset or desired values is performed in the controller 14 between the actual or input values. When a limit value is exceeded, starting with the controller 14, the engine management or an actuator is triggered, in order to initiate an emergency program of the internal combustion engine.

Furthermore, it has been proposed, in connection with the controller 14, to monitor the function of the tensioning device 8. For this purpose, a sensor 11c, which detects correcting movements of the tensioning device 8 rotating about a rotational axis 12 and transmits these movements to the controller 14 as a signal, is arranged on the internal combustion engine. From the actual value, the signal of the sensor 11c, the controller 14 calculates, in connection with defined desired values, an electrical control parameter, which can be converted, for example, by an actuator 15, which is in connection with the spring element 13 of the tensioning device 8. This measure enables, for example, an automatic adjustment of the tensioning device 8 for an impermissible elongation of the power transmission means 5 due to age.

The controller 14 is further connected to a control lamp 16, which is preferably arranged in the passenger compartment of the vehicle and which indicates to the driver that the emergency program has been initiated for the internal combustion engine or the position of the tensioning device 8 has been reset and simultaneously points to a necessary replacement of the power-transmission means 5.

The power transmission drive 1 designed as a synchronous drive and to be designated as a control drive forms a coupled drive with a second output-connected power transmission drive 17. For this purpose, the running wheel 22, the drive member 4b of the power transmission drive 1, takes over the function of a driven member for the power transmission drive 17. The power transmission means 18 connects the driven member, the running wheel 22 of the camshaft, with a drive member 19. For achieving sufficient tensioning of the power transmission means 18, a tensioning device 21 is allocated to this mechanism in the loose section 20. The drive member 19 is preferably a high-pressure pump or common rail pump for a diesel combustion engine. The high pressure pump placed between the cylinders of the internal combustion engine 2 arranged in the shape of a V, the drive member 19, enables an optimum mounting position and furthermore short connection lines to high-pressure diesel lines, which are allocated to each row of cylinders in the internal combustion engine 2.

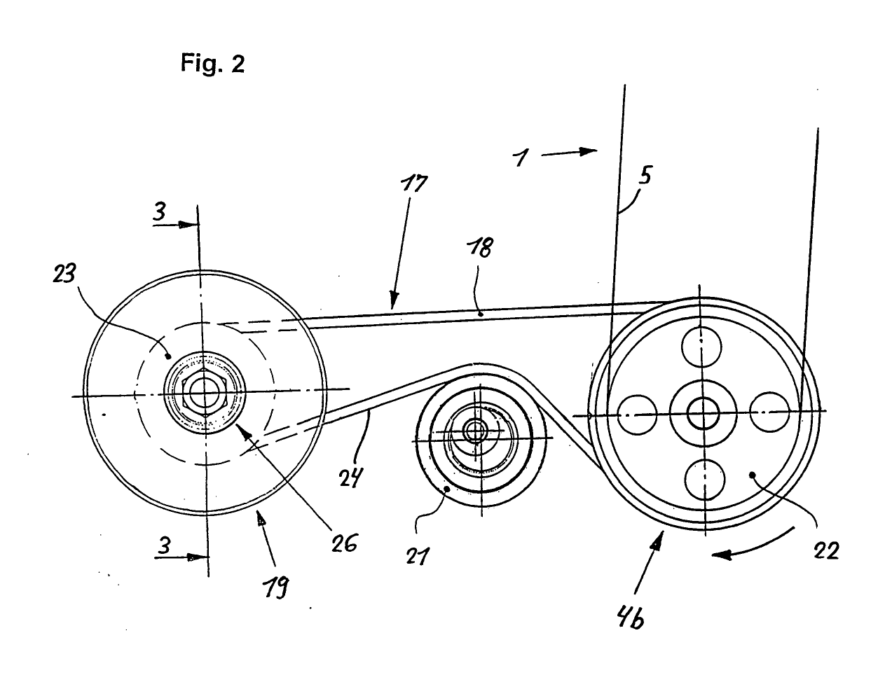

FIG. 2 shows in an enlarged view the power transmission drive 17, which forms a coupled drive to the power transmission drive 1. For this purpose, for the power transmission drive 17, the running wheel 22 designed for the power transmission drive 1 as a drive member 4b and locked in rotation with the camshaft of the internal combustion engine 2 forms a driven member. The power transmission means 18 connects the running wheel 22 of the camshaft to the running wheel 23, which is allocated to the drive member 19 provided as a diesel high-pressure pump. To achieve sufficient tensioning of the power transmission means 18, a tensioning device 21 enclosing an eccentric cam is supported with a positive fit in the loose section 24. As shown in FIG. 1, the power transmission drive 17 is arranged after the power transmission drive 1. A free engine clutch 26 integrated in the running wheel 23 of the drive member 19 prevents disadvantageous transmission of rotational irregularity from the high-pressure pump back to the running wheel 22 in connection with the camshaft.

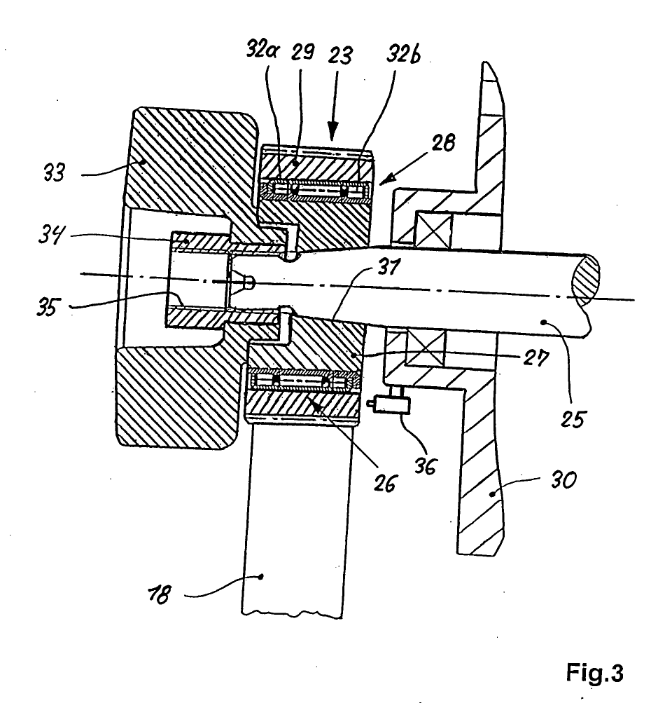

FIG. 3 shows the structure of the drive member 19, especially the installation position of the free engine clutch 26 within the running wheel 23. The running wheel 23 comprises an inner ring 27, which is locked in rotation with a pump shaft 25 and which is enclosed by an outer ring 29 at a distance in the radial direction, creating a circular ring installation space 28. The pump shaft 25 supported by bearings in a housing 30 of a high-pressure pump is here connected to the running wheel 23 via a press fit formed as a cone connection 31. The installation space 28 is used for holding the free engine clutch 26, to which is allocated, on both sides, a roller bearing 32a, 32b. Viewed from the housing 30, an oscillating mass 33, which is fixed by means of a nut 34, is mounted before the running wheel 23. The nut 34 screwed onto a threaded section 35 at the end of the pump shaft 25 exerts an axial force on the cone connection 31 via a shoulder of the oscillating mass 33.

A stationary sensor 36 positioned on the housing 30 is allocated to the outer ring 29 of the running wheel 23. Thus, for a defective free engine clutch 26, an angle deviation can be transmitted as a signal to the controller 1 shown in FIG. 1, wherein, after a limit value is exceeded, an emergency program can be initiated. For this purpose, the controller 14 or the regulating device is connected to the electronic control management of the internal combustion engine 2, such that, in the emergency program, for example, a full load on the internal combustion engine 2 is prevented or an rpm limit cannot be exceeded. This measure enables, even for a defective free engine clutch 26, the internal combustion engine 2 to continue to operate at least in partial load operation, so that the vehicle can reach a repair shop without outside help.

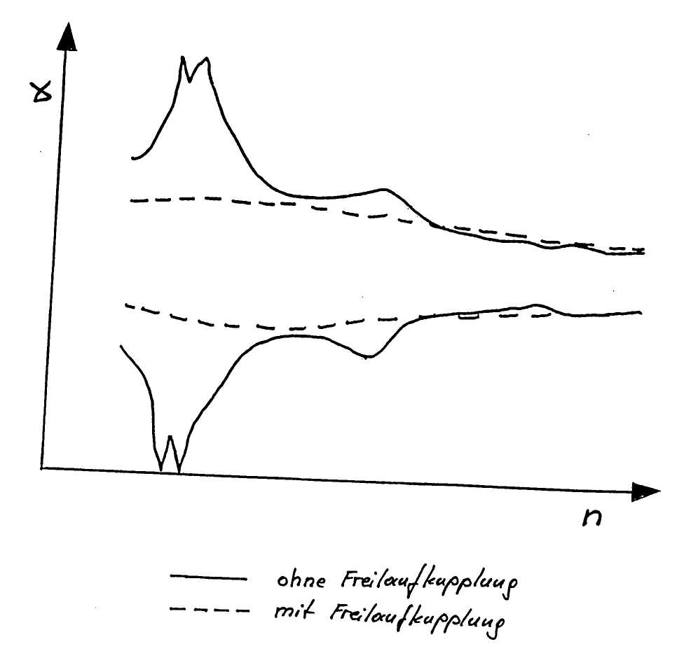

FIG. 4 shows the functioning of the free engine clutch 26, which is integrated in the drive member 19 according to FIG. 3. In the diagram, the oscillating angle or rotating angle deviation “a” is allocated to the ordinate and the rpm “n” is allocated to the abscissa. By means of the free engine clutch 26, the rotating angle deviation “a” is reduced over the entire rpm spectrum to a nearly constant level. Furthermore, it is made clear from the diagram that the free engine clutch 26 compensates, to a large degree, for particularly extreme angular deviations in a low rpm range.

### REFERENCE SYMBOLS

1 Power transmission drive
2 Internal combustion engine
3 Driven member
4a Drive member
4b Drive member
5 Power transmission means
6 Deflection roller
7 Deflection roller
8 Tensioning device
9 Tensioned section
10 Loose section
11a Sensor
11b Sensor
11c Sensor
12 Rotational axis
13 Spring element
14 Controller
15 Actuator
16 Control lamp
17 Power transmission drive
18 Power transmission means
19 Driven member
20 Loose section
21 Tensioning device
22 Running wheel
23 Running wheel
24 Loose section
25 Pump shaft
26 Free engine clutch
27 Inner ring
28 Installation space
29 Outer ring
30 Housing
31 Cone connection
32a Roller bearing
32b Roller bearing
33 Oscillating mass
34 Nut
35 Threaded section
36 Sensor

1. A power transmission drive (1, 17) comprising a synchronous drive for an internal combustion engine (2), with which a rotating angle between a driven member (3) and a drive member (4a, 4b; 19) can be detected, wherein a member of the power transmission drive (1, 17) includes an electronic controller (14) which interacts with a control system of the internal combustion engine (2), characterized in that a sensor (11a, 11b, 11c, 36), comprsing a transducer, detects an oscillating angle deviation, a rotating angle deviation, an irregularity in rpm, or a correcting movement between the driven member (3) and the drive member (4a, 4b; 19) and sends a signal to the controller (14), which calculates a control parameter, wherein after a defined limit value is exceeded, the controller (14) initiates an emergency program of the internal combustion engine, preferably through an actuator (15).

2. Device according to claim 1, wherein a free engine clutch (26) allocated to the driven member (3) or the drive member (4a, 4b; 19) protects a drive for an accelerated angular velocity of the power transmission drive (1, 17).

3. Device according to claim 1, wherein, for forming a coupled drive, a power transmission means (18) of the power transmission drive (17) is connected to a running wheel (22) of the power transmission drive (1) acting as a control drive for the internal combustion engine (2).

4. Device according to claim 3, wherein the power transmission drive (17) includes, as a drive member (19), a fuel pump, which, in connection with an associated sensor (36), the controller (14), and a free engine clutch (26), prevents full-load operation of the internal combustion engine (2) for a disruption in a function of the fuel pump.

5. Device according to claim 3, wherein a free engine clutch (26) is arranged in a running wheel (23) between an inner ring (27) locked in rotation with a pump shaft (25) and an outer ring (29) of the running wheel (23).

6. Device according to claim 4, wherein the free engine clutch (26) is inserted within a housing (30) of the fuel pump and connects to two journals of the pump, which is a high-pressure pump.

7. Device according to claim 2, wherein the free engine clutch (26) comprises a clamping body free-wheel or a clamping roller free-wheel.

8. Device according to claim 1, wherein the sensor (11c) is allocated to a unit of the power transmission drive (1), for example, a tensioning device (8), a camshaft adjuster, a deflection roller (6), or a water pump.

9. Device according to claim 1, wherein after an oscillating angle deviation, rotating angle deviation, or irregularity in rpm set as a limit value has been exceeded, the controller (14) triggers an acoustic and/or optical signal.

10. Device according to claim 1, wherein measurement values, which exceed the limit value, and also measurement values, which correspond to a tolerance range preset for the limit value, are stored in a fault memory of the controller (14).

11. Device according to claim 1, wherein the measurement of the rotating angle deviation between the drive member and the driven member is taken for a warm-running internal combustion engine.

12. Device according to claim 1, wherein, in an operating state of the internal combustion engine (2), in connection with the at least one sensor (11a, 11b, 11c, 36) and the controller (14), a continuous comparison of measurement values is performed by the controller for determining an oscillating angle deviation, an irregularity in rpm, or a rotating angle deviation between the driven member (3) and the drive member (4a, 4b; 19).

13. Device according to claim 1, wherein the power transmission means (5, 18) for the power transmission drive (1, 17) comprises a toothed belt.

14. Device according to claim 1, wherein a tensioning device (8, 21) is allocated to a loose section (20, 24) of the power transmission drive (1, 17).

15. Device according to claim 4, wherein the fuel pump, which is pivotally supported against a spring element simultaneously acts as a tensioning device (21) of the power transmission drive (17).

16. Device according to claim 1, wherein the power transmission drive (1) includes a starter generator, with which the internal combustion engine (2) is started in a start mode, and the internal combustion engine (2) drives the power transmission drive (1) in a generator mode.
